(19) United States
(12) Patent Application Publication
(10) Pub. No.: US 2007/0071331 A1
(43) Pub. Date: Mar. 29, 2007

(54) Image compression by economical quaternary reaching method

(75) Inventor: Xiteng Liu, Columbia, SC (US)

Correspondence Address: XITENG LIU, 101 PICKENS ST., APT. K-4, COLUMBIA, SC, 29205, US

(73) Assignee: Xiteng Liu, Columbia, SC (US)

(21) Appl. No.: 11/162,829

(22) Filed: Sep. 24, 2005

(51) Int. Cl. G06K 9/36

(52) U.S. Cl. 382/232

(57) ABSTRACT

In wavelet-based image compression schemes, a very sparse representation of the image signal may be obtained after quantization to transform coefficients. In addition, the nonzero coefficients 2-dimensionally cluster around the edge or texture areas. In existing systems, for example JPEG2000, in the bit-plane coding process, coefficients are repeatedly scanned and encoded in a 1-dimensional pattern within code-blocks. A large number of zeros have to be encoded to record the distribution of significant coefficients. It inevitably causes a big loss of compression performance. Quaternary reaching method emphasizes reaching and encoding the significant coefficients in 2-dimensional pattern. It fully adapts to the 2-dimensional character of the significance distribution of quantized coefficients. Besides, it admits very economical implementation. The recording of redundant information is drastically reduced. As result, it magnificently enhances both compression performance and computation performance against existing systems.

### FIELD OF THE INVENTION

The present invention relates to the field of digital image compression.

### BACKGROUND OF THE INVENTION

In JPEG2000, as described in Final Committee Draft Version 1.0 (ISO/IEC JTC 1 /SC 29/WG 1 N1646R, 16 Mar. 2000), the original image data is firstly preprocessed by component transform. Each component is divided into some rectangular tiles. Then, the component data in tiles are decomposed into some sub-bands using wavelet transform. In each sub-band, wavelet coefficients are divided into rectangular code-blocks. The coefficients in code-blocks are encoded/decoded bit-plane by bit-pane. Within code-blocks, the bits of coefficients at each bit-plane are scanned and encoded in a particular pattern. Starting from the top left of the code-block, the first four bits of the first columns are scanned followed by the four bits of second column, until the width of the code-block is covered. Then, the second four bits of first column are scanned and so on. It is apparent that this sample-by-sample scan pattern is 1-dimensional. Thus a large number of zeroes have to be encoded in order to record the positions of significant coefficients. Although run-length coding for zeroes may be employed under some condition in the cleanup pass, the chance to reduce coding redundant information is relatively very small. Consequently, the 1-dimensional scan pattern causes big losses in both compression performance and computation performance.

The wavelet coefficients represent the local frequency information at different resolution of image signal. The image information mainly concentrates on relatively few wavelet coefficients. After quantization, a very sparse approximate representation of the image signal can be obtained. Moreover, the sparse nonzero coefficients 2-dimensionally cluster around edge or texture areas. At each bit-plane, the significance distribution is even more sparse and accumulative. Therefore, a 1-dimensional scan pattern can not reach the significant coefficients very efficiently.

### SUMMARY OF THE INVENTION

Since significant wavelet coefficients 2-dimensionally cluster in the sea of zeroes, it is desirable to reach them in 2-dimensional pattern. One method described herein involves reaching and encoding/decoding significant coefficients in a 2-dimensional quaternary pattern. Initially, the matrix of coefficients obtained by decomposing the image data using wavelet transform is partitioned into equal-size squares with size 2ⁿ×2ⁿ. At each bit plane, from the most significant bit-plane to the least significant bit-plane, every significant (not-all-zero) square is recursively divided into four smaller squares by evenly dividing the height and width, until single coefficients are reached. Then, the significance status of all generated squares and those coefficients in significant squares are encoded. As result, the total quantity of information needs to record and the number of coding operations to reach significant coefficients in the bit-plane coding process are drastically reduced.

In order to encode/decode the image signal more efficiently, some economical coding schemes are accordingly designed and fulfilled. Firstly, the initial squares are identified as significant (not-all-zero) or insignificant (all-zero) and the notation map is recorded. Only significant squares are repeatedly visited and encoded in quaternary reaching pattern during the bit-plane coding process. Second, while encoding the significance status bit-plane by bit-plane, all previously fully encoded squares, initial or generated, and encoded coefficients are never visited again. Third, each sub-band of wavelet coefficients is partitioned into four or more districts. The starting bit-plane, i.e. the most significant bit-plane, of every district is recorded. During the bit-plane coding process, each district is encoded from its own starting bit-plane. Besides others described in the hereafter detailed description, the economical coding schemes turn out very helpful to enhance the compression performance.

### DETAILED DESCRIPTION OF THE PREFERED EMBODIMENT

A method for greatly enhancing compression performance in an image compression system is described herein. Meanwhile, an image compression system implementing the proposed method with economical coding schemes is firstly described in detail for one skilled in the art to practice the present invention easily.

The Image Compression System Based on Quaternary Reaching Method

The encoding procedure of the image compression system proposed in the present invention comprises steps of: preprocess, wavelet transform, quantization, value map coding, bit steam modeling.

Before wavelet transform, the original RGB component data of color images is transformed into YC_{b}Cᵣ form. The hereafter image compression operations are fulfilled to YC_{b}Cᵣ components respectively. For grey scale images, the encoding operations are directly fulfilled to the original image data without component transform.

The Daubechies 9-7 biorthogonal wavelet transform is implemented by lifting scheme in the present invention of image compression system.

The present invention of image compression system adopts a band-oriented quantization mechanism. The coefficients at different sub-band are quantized by different scalar step sizes. To different image quality, the step sizes are determined by the multiple of the base step sizes and a common quality factor. This mechanism is close to the fixed frequency weighting quantization recommended by JPEG 2000 Part I Final Committee Draft Version 1.0.

After quantization, a very sparse approximate representation of the image signal is obtained. One method to dramatically squeeze the coding space and rule out large tract of zeroes from bit-plane coding operation is proposed in the present invention. Firstly, identify the initial squares of quantized coefficients as significant if it is not-all-zero or insignificant if it is all-zero. Then, record the notation map, value map, by quadtree algorithm. The hereafter described bit stream modeling operations only occur to initially significant squares.

The bit stream modeling is fulfilled bit-plane by bit-plane. At each bit-plane, all initially significant squares of coefficients are visited and encoded in the hereafter described 2-dimensional quaternary reaching pattern. The bit stream of compressed image data is composed of sign stream, complement stream and significance status streams corresponding to the quaternary reaching levels. The sign stream is generated by context-based arithmetic coding engine while encoding the signs of significant coefficients. The complement stream is formed by the complement bits of the magnitudes of significant coefficients. The complement bits of an integer are all bits other than the most significant bit of the integer. The significance status stream of each quaternary level is also generated by arithmetic coding engine.

2-Dimensional Quaternary Reaching Pattern

The most costly task for a transform-based image compression scheme is to record the locations of significant coefficients. The location of a significant coefficient is even more expensive to encode than its magnitude because of the sparse distribution of significance. To record as few zeroes as possible before reaching significant coefficients, a 2-dimensional scan pattern is indispensable. The 2-dimensional quaternary pattern should be the most efficient way to reach the sparse and clustered significant coefficients. In detail, a 3-level quaternary reaching process is illustrated as an example hereafter.

Within a significant 8×8 square of wavelet coefficients, the first level quaternary reaching process generates four squares with size 4×4 by evenly dividing the width and height. Then, the significance status of the four squares is encoded. Only within significant 4×4 squares, the second level quaternary reaching process generates 2×2 squares. The significance status of generated 2×2 squares is encoded as well. Finally, as the third level reaching, the significance status of all single coefficients in those significant 2×2 squares is encoded. Apparently, this reaching pattern is far more efficient than the 1-dimensional scan pattern of JPEG 2000 in reducing the chance of encoding redundant information and hence the computation complexity.

Economical Coding Schemes

Besides the value map coding process, some other economical coding schemes are designed in the present invention to improve the compression performance.
(1) Special array is created to record the number of encoded elements of the squares at each quaternary reaching level. The data in these arrays are also used to determine the context of arithmetic coding for significance status. After all elements of a square have encoded/decoded, the square will never be visited again.
(2) After a square is found significant, its significance status at lower bit-planes will never be encoded/decoded.
(3) After quantization, all 2×2 squares in initially significant squares are checked. If the magnitude sum of the four coefficients is one, then reset the 2×2 square as all-zero.
(4) Each sub-band of wavelet coefficients is partitioned into four or more districts. The starting bit-plane, i.e., the most significant bit-plane of every district is recorded. During the bit-plane coding process, each district is encoded from its own starting bit-plane.
   Difference between Quaternary Reaching Method and Block Coding of EBCOT

The essential difference between quaternary reaching method and block coding of EBCOT lies in the scan pattern within code-blocks or sub-blocks. In EBCOT, as described in High Performance Scalable Image Compression with EBCOT, IEEE TRANSACTION ON IMAGE COMPRESSION, VOL. 9, NO.7, JULY 2000, David Taubman, the scan pattern within code-blocks (sub-blocks) is 1-dimensinal, sample-by-sample. By contrast, the scan pattern within code-blocks (squares) in the present invention is 2-dimensional quaternary as described above. In EBCOT, the typical size of sub-blocks is 16×16 or 8×8 in code-blocks with size 64×64 or 32×32. With quaternary reaching pattern, for example, within a 16×16 significant square, there should recursively generate squares with size 8×8, 4×4 and 2×2 to reach single significant coefficient(s).

Performance Comparison with JPEG2000

In JPEG2000, three optional quantization strategies are recommended: scalar coefficient quantization, fixed visual weighting and visual progressive coding. With different quantization mechanism, the numerical measurement PSNR and the subjective image quality have totally different correspondence, as shown in Visual progressive Coding, Proceedings of IS&T/SPIE Conference on Visual Communications and Image Processing, San Jose, Calif., Vol. 3653, January 1999, Jin Li. Hence, for fair comparison in terms of PSNR, the same quantization mechanism should be applied. In Table 1, the PSNR reports for the image compression system, EQR system, described in the present invention and JPEG 2000 are both based on fixed frequency weighting quantization with the same weighting set at view distance 1000 pixels as recommended in JPEG 2000 Part I Final Committee Draft Version 1.0. The PSNR reports for JPEG 2000 are from Report on CE V1 (CSF Weighting Strategy for Visual Progressive Coding), ISO/IEC JTC1/SC29/WG1N1584, 13 Mar. 2000, Wenjun Zeng etc. Under fixed frequency weighting quantization with the same weighting set, an approximate 2dB increase in PSNR indeed represents a magnificent enhancement in visual image quality and hence in compression performance. It undoubtedly shows that the 2-dimensional quaternary reaching method described in the present invention is far more efficient than the 1-dimensional scan pattern within code-blocks of JPEG 2000.

TABLE 1
The PSNR comparison between JPEG2000 and EQR while compress
image Lenna

| Bit rate (bpp) | JPEG 2000 PSNR (dB) | EQR PSNR (dB) |
|---|---|---|
| 1 | 37.48 | 39.36 |
| 0.75 | 36.47 | 38.45 |
| 0.5 | 35.03 | 36.51 |
| 0.25 | 32.15 | 33.44 |

(512×512).

On the other hand, at the same or close PSNR, EQR system in the present invention makes overall better visual image quality than JPEG 2000. By observation, under same viewing condition, the JPEG2000-compressed images show more ringing artifacts around edge areas than EQR-compressed images. Meanwhile, the texture areas in JPEG2000-compressed images look slightly better than in EQR-compressed images. Because the ringing artifacts are more annoying, the overall subjective quality of EQR-compressed images is better than that of JPEG2000-compressed images. An analysis of the algorithms in the two systems can explain the difference. In JPEG 2000, rate-distortion optimization scheme is applied which emphasize more on texture area where big wavelet coefficients cluster more densely than edge area. Rate-distortion optimization is mainly oriented to improve PSNR instead of visual quality. By contrast, without rate-distortion optimization, EQR system in the present invention takes evenly scalar quantization and record all quantized coefficients. So the coefficients around edge areas are given more care than in JPEG2000. As result, the overall visual image quality gets better.

What is claimed is:

1. A method for compressing digital image data, comprising steps of: decomposing the original image data into a hierarchically arranged matrix using a transform; partitioning the matrix into equal-size squares of coefficients with size 2ⁿ×2ⁿ; at each bit-plane, from the most significant bit-plane to the least significant bit-plane, recursively dividing every significant (not-all-zero) square into four smaller squares in 2-dimensional quaternary pattern by evenly dividing the height and width; then recording the significance status of all generated squares until single significant coefficients are reached and encoded.

2. A method as claimed in claim 1, wherein all initial squares are identified as significant (not-all-zero) or insignificant (all-zero) before the bit-plane coding process. This notation map is encoded separately by quadtree algorithm. The coding process as claimed in claim 1 only occurs to initially significant squares.

3. An image compression system, comprising: decomposing original image data into a hierarchical arranged matrix using a transform, quantizing the transform coefficients with a quantization mechanism, partitioning the matrix into squares with size 2ⁿ×2ⁿ and identifying each square as significant (not-all-zero) or insignificant (all-zero), recursively dividing each significant square into four smaller squares in a 2-dimensional quaternary pattern and encoding significance status of all generated squares until single coefficients in significant squares are reached and encoded, bit-plane by bit-plane.

4. An image compression system as claimed in claim 3, wherein n=2.
